(19) United States
(12) Patent Application Publication
(10) Pub. No.: US 2021/0350708 A1
(43) Pub. Date: Nov. 11, 2021

(54) APPARATUS FOR CONTROLLING PLATOONING, SYSTEM INCLUDING THE SAME, AND METHOD FOR THE SAME

(71) Applicants: HYUNDAI MOTOR COMPANY, SEOUL (KR); KIA MOTORS CORPORATION, SEOUL (KR)

(72) Inventor: Kyeong Eun KIM, Gyeonggi-do (KR)

(73) Assignees: HYUNDAI MOTOR COMPANY, SEOUL (KR); KIA MOTORS CORPORATION, SEOUL (KR)

(21) Appl. No.: 17/065,320

(22) Filed: Oct. 7, 2020

(30) Foreign Application Priority Data
May 6, 2020 (KR) 10-2020-0053889

(51) Int. Cl. G08G 1/00; G08G 1/052

(52) U.S. Cl. CPC G08G 1/22; G08G 1/052

(57) ABSTRACT

An apparatus for controlling platooning, a system including the same, and a method for the same are provided. The apparatus for controlling platooning includes a processor to control the platooning, and a memory to store platoon arrangement information of platooning vehicles during the platooning. The processor may automatically form a platoon based on the platoon arrangement information stored in the memory when controlling the platooning.

### CROSS-REFERENCE TO RELATED APPLICATION

This application claims priority to and the benefit of Korean Patent Application No. 10-2020-0053889, filed on May 6, 2020, the entire contents of which are incorporated herein by reference.

### TECHNICAL FIELD

The present disclosure relates to an apparatus for controlling platooning, a system including the same, and a method for the same, and more particularly to a technology of allowing Quick start for platooning based on previously stored information on a platoon arrangement.

### BACKGROUND

Platooning is a technology that a plurality of vehicles, which are arranged with each other in line while being spaced apart from each other by a specified distance, perform autonomous driving. During platooning, a leading vehicle, which is positioned at the front most of a platoon, may control at least one following vehicle which follows the leading vehicle. The leading vehicle may maintain the distance between the plurality of vehicles included in the platoon and may exchange the behaviors of the plurality of vehicles included in the platoon and situation information through inter-vehicle communication.

In this case, when the following vehicle transmits, to the leading vehicle, a request for joining the following vehicle into a platoon, and the leading vehicle approves the joining, the platoon may be made.

Platooning may be continuously performed to a destination in the state that the same vehicles are making the same platoon, or may be newly performed with vehicles belonging to a previous platoon at the destination. However, when an engine is turned off for a break and then turned on, during platooning, the platoon may be dismissed. Accordingly, as the request for joining following vehicles into the platoon and the approval of the platooning have to be repeated to make the platoon, a break time of a driver may be reduced due to the inconvenient procedure, so a traffic accident may occur.

### SUMMARY

An aspect of the present disclosure provides an apparatus for controlling platooning, a system including the same, and a method for the same, in which when it is determined, based on platoon history information, that a vehicle has a history that the vehicle has ever formed a platoon, the platoon may be formed through direct control transfer without request and approval procedures.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for controlling platooning may include a processor to control the platooning, and a memory to store platoon arrangement information of platooning vehicles during the platooning, and the processor may automatically form a platoon string based on the platoon arrangement information stored in the memory when starting the controlling of the platooning.

According to an embodiment, the memory may store the platoon arrangement information by mapping a role on the platooning line and a vehicle identification (ID) of each of the platooning vehicles to each other.

According to an embodiment, the processor may control to store present platoon arrangement information of the platooning vehicles in the memory when the platooning vehicles are in ‘Maintain mode’.

According to an embodiment, the processor may control to determine whether platoon arrangement information which is previously stored, is present in a memory region, which is selected by a user, when storing the platoon arrangement information in the memory, and to provide the previously stored platoon arrangement information when the previously stored platoon arrangement information is present.

According to an embodiment, the processor may delete the previously stored platoon arrangement information in response to a request of a user, and store present platoon arrangement information, when the previously stored platoon arrangement information is present.

According to an embodiment, the processor may notify that the present platoon arrangement information is stored in the memory.

According to an embodiment, the processor may determine whether to set approval of Quick start control over the platooning vehicles corresponding to the platoon arrangement information stored in the memory, to automatically form the platoon string.

According to an embodiment, the processor may receive, from following vehicles of the platooning vehicles, setting information for approval of Quick start control over the following vehicles, and determine whether a vehicle, which does not approve the Quick start control, of the following vehicles is present.

According to an embodiment, the processor may determine that automatic platooning is failed, when at least one following vehicle, which does not approve the Quick start control, is present of the following vehicles, and notify that the automatic platooning is failed.

According to an embodiment, the processor may determine whether the platooning is possible by receiving sensor information and vehicle information from the following vehicles, when all the following vehicles approve the Quick start control.

According to an embodiment, the processor may determine and notify that the platooning is failed when it is determined that a sensor is failed, an engine is turned off, a vehicle control is failed, and a distance to a front vehicle is within a preset distance, based on the sensor information and the vehicle information received from the following vehicles.

According to an embodiment, the processor may determine whether the platooning vehicles are arranged based on the platoon arrangement information stored in the memory, when the platooning is possible, and start the platooning when the platooning vehicles are arranged based on the platoon arrangement information stored in the memory.

According to an embodiment, the processor may compare a speed of a first following vehicle of the following vehicles with a speed of the first following vehicle, which is measured by a front sensor of a second following vehicle travelling in back of the first following vehicle, when the platooning is possible, determine whether the second following vehicle is travelling in back of the first following vehicle, and verify the platoon arrangement.

According to an embodiment, the processor may verify the platoon arrangement with respect to all the following vehicles, and start the platooning when the verification of the platoon arrangement is completed with respect to all the following vehicles.

According to an embodiment, the processor may notify that the verification of the platoon arrangement is failed with respect to at least one of the following vehicles, when the verification of the platoon arrangement is failed with respect to the at least one of the following vehicles.

According to an embodiment, the processor may determine platooning modes of all following vehicles based on inter-vehicle distances between all the following vehicles and front vehicles of all the following vehicles, when the platooning is started.

According to an embodiment, the processor may determine the platooning mode to be ‘Manual mode’ when the inter-vehicle distance is longer than a first reference value, determine the platooning mode to be ‘Semi-auto approach mode’, when the inter-vehicle distance is longer than a second reference value shorter than the first reference value and shorter the first reference value, determine the platooning mode to be ‘Autonomous approach mode’, when the inter-vehicle distance is longer than a third reference value shorter than the second reference value and shorter the second reference value, and determine the platooning mode to be ‘Maintain mode’, when the inter-vehicle distance is longer than a fourth reference value shorter than the third reference value and shorter the third reference value.

According to an embodiment, the processor may transmit a command for the platooning mode to all the following vehicles in parallel such that all the following vehicles perform the platooning mode in parallel.

According to an aspect of the present disclosure, a vehicle system may include a communication device to communicate between platooning vehicles, a platooning control apparatus to store platoon arrangement information of the platooning vehicles during controlling the platooning and to automatically perform the platooning based on the stored platoon arrangement information when the controlling of the platooning is started, and an interface device to display the platoon arrangement information.

According to an aspect of the present disclosure method for controlling platooning may include storing platoon arrangement information of platooning vehicles during the platooning, and automatically performing the platooning based on the stored platoon arrangement information when the controlling of the platooning is started.

### DRAWINGS

In order that the disclosure may be well understood, there will now be described various forms thereof, given by way of example, reference being made to the accompanying drawings, in which:

FIG. 1 is a block diagram illustrating the configuration of a vehicle system including an apparatus for controlling platooning, in one form of the present disclosure;

FIG. 2 is a view illustrating a screen of a platooning arrangement, in one form of the present disclosure;

FIG. 3 is a view illustrating information stored in a memory of an apparatus for controlling platooning, in one form of the present disclosure;

FIG. 4 is a view illustrating a screen of a menu for a plurality of memories in an apparatus for controlling platooning, in one form of the present disclosure;

FIG. 5 is a view illustrating a screen for storing a platooning arrangement in a memory, in one form of the present disclosure;

FIG. 6 is a view illustrating a screen of detailed values for a memory, in one form of the present disclosure;

FIG. 7 is a view illustrating a screen for setting of Quick start, in one form of the present disclosure;

FIG. 8 is a view illustrating a screen for notifying failure of Quick start, in one form of the present disclosure;

FIG. 9 is a flowchart illustrating a storing method of a platoon memory, in one form of the present disclosure;

FIG. 10 is a flowchart illustrating a method for performing Quick start in platooning, in one form of the present disclosure;

FIG. 11 is a flowchart illustrating a method for performing Quick start in platooning, in one form of the present disclosure; and

FIG. 12 is a block diagram illustrating a computing device, in one form of the present disclosure.

### DETAILED DESCRIPTION

Hereinafter, some embodiments of the present disclosure will be described in detail with reference to accompanying drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the teams do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined in the present application.

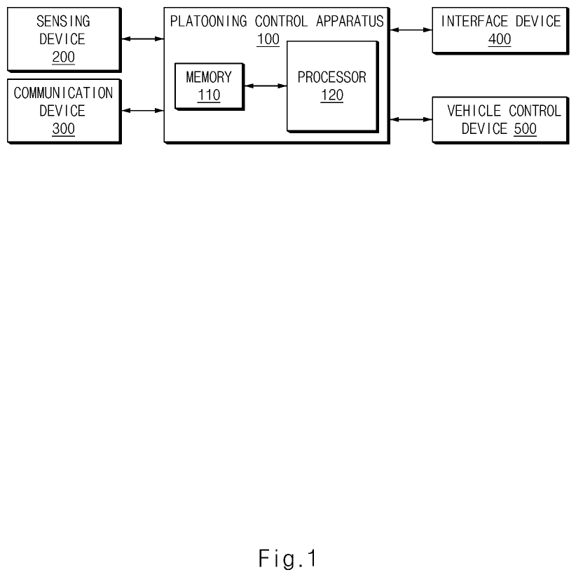

Hereinafter, embodiments of the present disclosure will be described in detail with reference to FIGS. 1 to 12.

A leading vehicle (LV) and a following vehicle (FV) included in a platoon may perform platooning on a road. The leading vehicle (LV) and the following vehicle (FV) may travel while maintaining a specific distance therebeween. The leading vehicle (LV) or the following vehicle (FV) may adjust the distance between the leading vehicle (LV) and the following vehicle (FV) while traveling. The leading vehicle (LV) or the following vehicle (FV) may increase or decrease the inter-vehicle distance depending on the operation of a driver.

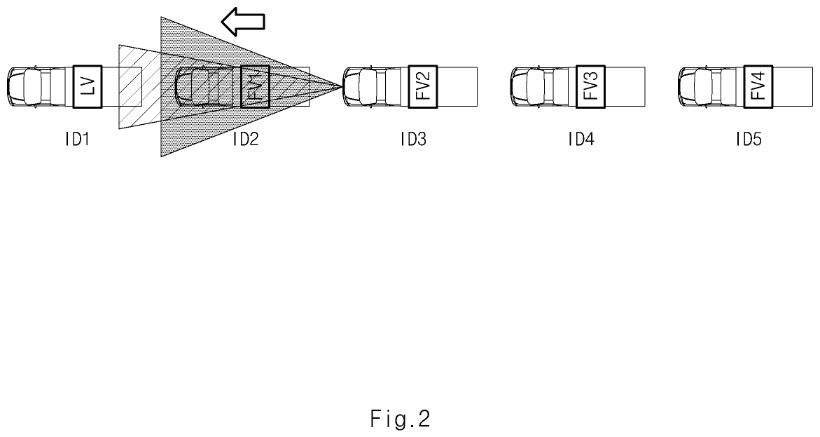

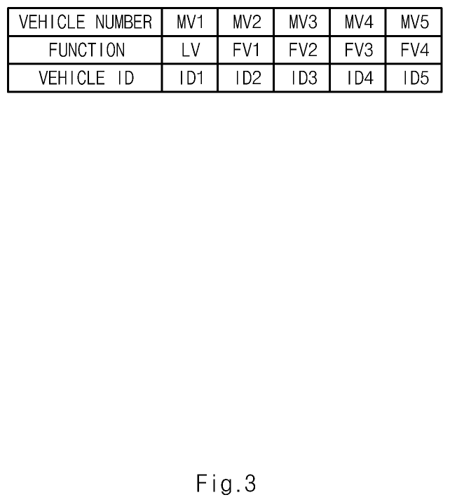

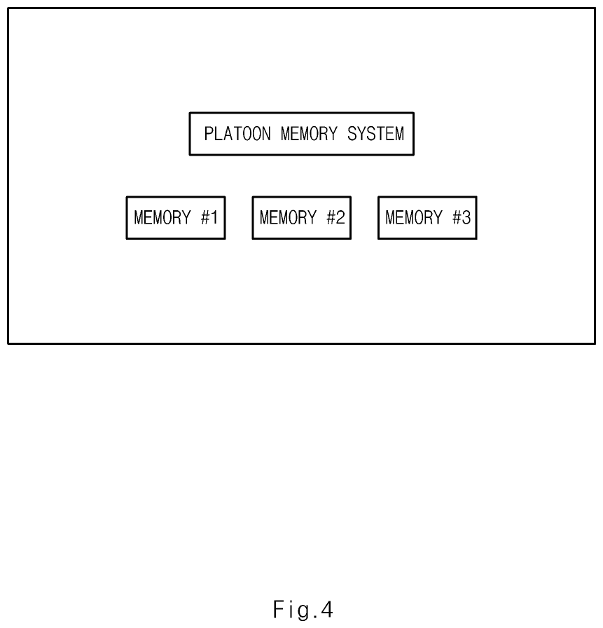

According to the present disclosure, a platoon arrangement may be stored in the memory, and an example of storing the platoon arrangement in the memory will be described with reference to FIGS. 2 and 3 in detail later. Hereinafter, the details of a user interface provided by the leading vehicle (LV) or the following vehicle (FV) to store the platoon arrangement will be described with reference to FIGS. 4 to 8.

FIG. 1 is a block diagram illustrating the configuration of a vehicle system including an apparatus (platooning control apparatus) for controlling platooning, according to an embodiment of the present disclosure.

Referring to FIG. 1, according to an embodiment of the present disclosure, a platooning control apparatus 100 may be realized inside a vehicle. In this case, the platooning control apparatus 100 may be formed integrally with the internal control units of the vehicle or may be implemented separately from the internal control units of the vehicle to be connected with the internal control units of the vehicle through a separate connector.

Referring to FIG. 1, the platooning control apparatus 100 may include a memory 110 and a processor 120.

The memory 110 may be classified into a plurality of memory regions for use, and numbers may be assigned to the plurality of memory regions. For example, the memory 110 may be classified into memory #1, memory #2, and memory #3 as illustrated in FIG. 4. In addition, mutually different pieces of information (platooning arrangement information) on the platoon arrangement may be stored in memory #1, memory #2, and memory #3, respectively. In this case, the platoon arrangement information may include a vehicle number, a vehicle identification (ID), a platooning role (platoon order for each vehicle) for each vehicle, information on time spent to perform platooning, or information on a platooning history.

The memory 110 may store the sensing result of the sensing device 200, and data and/or algorithms necessary for the platooning control apparatus 100 to operate. For example, the memory 110 may store the platoon arrangement information received from platooning vehicles through Vehicle to Everything (V2X) communication, and the platoon arrangement information may include position information, a sensing value obtained through the sensing device of each vehicle, vehicle information, such as a vehicle speed, calculated by each vehicle, a setting value, information on a destination, or information on a route.

In addition, the memory 110 may be implemented with at least one storage medium of a memory in a flash memory type, a hard disk type, a micro type, the type of a card (e.g., a Security Digital (SD) card or an eXtreme digital card), a Random Access Memory (RAM), a Static RAM (SRAM), a Read Only Memory (ROM), a Programmable ROM (PROM), an Electrically Erasable and Programmable ROM (EEPROM), a magnetic RAM (MRAM), a magnetic disk-type memory, or an optical disk-type memory.

The processor 120 may be electrically connected with the memory 110 and may electrically control each component. The processor 120 may be an electric circuit that executes software commands. Accordingly, the processor 120 may perform various data processing and calculation to be described below. The processor 120 may be, for example, an electronic control unit (ECU), a micro controller unit (MCU), or another lower-level controller mounted in the vehicle.

The processor 120 may perform requesting for the approval of platooning, making platooning due to the approval of the platooning, and determining a platooning mode, for controlling platooning. In this case, the platooning mode may be classified into ‘Manual mode’, ‘Semi-auto approach mode’, ‘Autonomous approach mode’, and ‘Maintain mode’.

In this case, in ‘Manual mode’, a driver may perform both longitudinal control and lateral control. In ‘Semi-auto approach mode’, the processor 120 performs the longitudinal control over the vehicle and the driver may personally perform lateral control. In ‘Autonomous approach mode’, the processor 120 performs both the longitudinal control and the lateral control over the vehicle. In ‘Maintain mode’, the processor 120 performs both the longitudinal control and the lateral control over the vehicle and performs inter-vehicle distance control. As described above, when all following vehicles (FVs) in a platoon string enter ‘Maintain mode’, platooning may be started and a present platoon arrangement may be stored in the memory 110.

The processor 120 may automatically perform platooning depending on the platoon arrangement information previously stored in the memory 110.

When the platoon arrangement information is stored in the memory 110, the processor 120 may determine whether the platoon arrangement information, which is previously stored, is present in a memory selected by a user. When the platoon arrangement information is previously stored in the memory, the processor 120 may control such that the previously stored platoon arrangement information is provided through the interface device 400. In this case, the platoon arrangement information stored in the memory 110 may be displayed as illustrated in FIG. 4. Accordingly, the user of the leading vehicle (LV) may identify the platoon arrangement information which is previously stored.

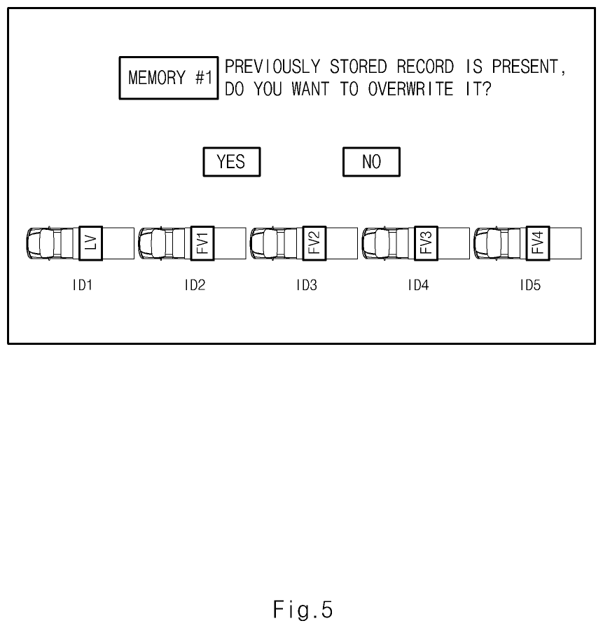

When there is present the platoon arrangement information previously stored in the memory 110, the processor 120 may receive, from a user, a selection for whether the relevant memory is overwritten as illustrated in FIG. 5. When the overwriting is requested by the user, the processor 120 may delete the previous-stored platoon arrangement information from the memory and may store present platoon arrangement information in the relevant memory. In addition, the processor 120 may display the present platoon arrangement information stored in the memory 110 through the interface device 400 and notify the user of the present platoon arrangement information stored in the memory 110.

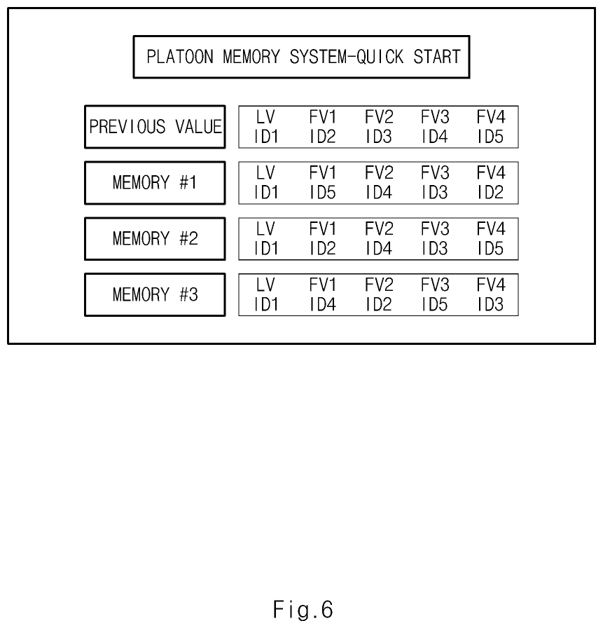

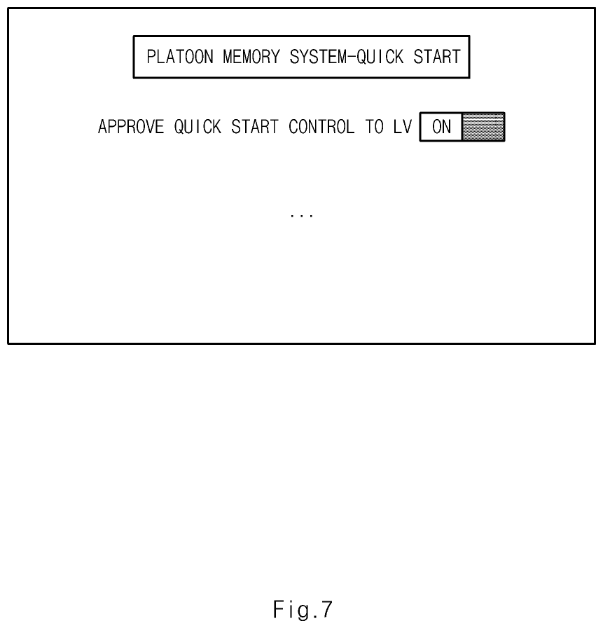

The processor 120 may determine whether to set approval of Quick start control over platooning vehicles corresponding to the platoon arrangement information stored in the memory 110, so as to automatically perform platooning. In other words, the processor 120 may request following vehicles (FVs) of platooning vehicles to provide setting values and may receive the setting values from the following vehicles (FVs). The processor 120 may determine an approval state for the Quick start control over the following vehicles (FVs) using the received values. When a memory is selected for Quick start as illustrated in FIG. 6, the platoon arrangement information stored in the memory may be displayed, and the setting value may be displayed as illustrated in FIG. 7.

When there is present at least one following vehicle (FV), which is not approved in Quick start control, of the following vehicles (FVs), the processor 120 may determine that automatic platooning is failed, the processor 120 may notify the user of that the automatic platooning is failed. In this case, the processor 120 may control to notify users of the following vehicles (FVs) by transmitting, to following vehicles (FVs), that the automatic platooning is failed.

When all the following vehicles (FVs) are approved in Quick start control, the processor 120 may request and receive sensor information and vehicle information from the following vehicles (FVs) and may determine whether the platooning is possible.

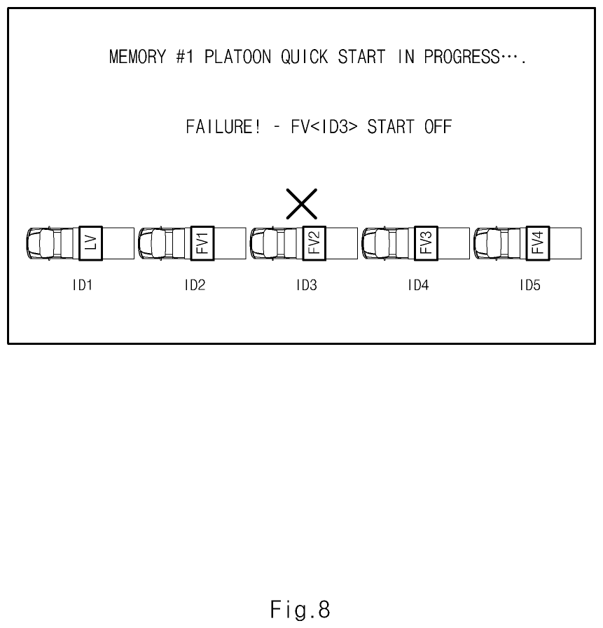

The processor 120 may determine that the platooning is failed, when it is determined that the state of the following vehicles is at least one of a failure state of a sensor, a start off state, a vehicle control failed state, or a state that an inter-vehicle distance to the front vehicle is equal to or greater than a preset distance, based on the sensor information and the vehicle information received from the following vehicles, and may provide a state indicating platooning failed through the interface device 400 as illustrated in FIG. 8. In this case, the processor 120 may control to notify users of the following vehicles (FVs) by transmitting, to the following vehicles (FVs), that the automatic platooning is failed.

As described above, the processor 120 may determine the platooning as being possible, when all following vehicles (FVs) approves Quick start control, and when the sensors of the all following vehicles (FVs) are not failed.

When the platooning is possible, the processor 120 may determine whether the platooning vehicles are arranged based on the platoon arrangement information stored in the memory 110. When the platooning vehicles are arranged based on the platoon arrangement information stored in the memory 110, the processor 120 may control to start the platooning.

In other words, when the platooning is possible, the processor 120 may compare the speed of a first following vehicle of the following vehicles with the speed of the first following vehicle, which is measured by a front sensor of a second following vehicle travelling in back of the first following vehicle, to determine whether the second following vehicle is travelling in back of the first following vehicle, thereby performing the verifying the platoon arrangement.

The processor 120 may perform the verification of the platoon arrangement with respect to all following vehicles. When the verification of the platoon arrangement with respect to the all following vehicles is completed, the processor 120 may control the all following vehicles to perform the platooning. When the verification of the platoon arrangement is failed with respect to the at least one of the following vehicles, the processor 120 may notify that the verification of the arrangement of the relevant following vehicle is failed.

Although the above description has been made regarding that the user of the leading vehicle (LV) selects platoon arrangement information stored in the memory, verifies whether the following vehicles (FVs) are arranged based on the stored platoon arrangement information, and starts platooning, but the present disclosure is not limited thereto. For example, users manually may arrange following vehicles (FVs) in the sequence, which is stored in the memory during vehicle travelling, to start the platooning as soon as the user of the leading vehicle (LV) selects the memory.

The processor 120 may determine platooning modes of all following vehicles (FVs) based on the distances between all following vehicles (FVs) and front vehicles of the all following vehicles (FVs) when platooning starts. In other words, when the inter-vehicle distance is longer than a first reference value, the processor 120 may determine a platooning mode to be ‘Manual mode’. When the inter-vehicle distance is longer than a second reference value shorter than the first reference value and shorter than the first reference value, the processor 120 may determine the platooning mode to be ‘Semi-auto approach mode’. When the inter-vehicle distance is longer than a third reference value shorter than the second reference value and shorter than the second reference value, the processor 120 may determine the platooning mode to be ‘Autonomous approach mode’. When the inter-vehicle distance is longer than a fourth reference value shorter than the third reference value and shorter than the third reference value, the processor 120 may determine the platooning mode to be ‘Maintain mode’. Accordingly, the following vehicles (FVs) may perform the platooning depending on the platooning modes received from the leading vehicle (LV).

The processor 120 may transmit commands for the platooning modes to all following vehicles (FVs) in parallel and the all following vehicles (FVs) may perform the platooning modes in parallel. Accordingly, the platooning control over the platooning vehicles may be rapidly performed.

The sensing device 200 may include at least one sensor to detect an obstacle, such as a preceding vehicle, positioned around a host vehicle, and to measure a distance to the obstacle and/or a speed relative to the obstacle. For example, the sensing device 200 may include a front sensor and a rear sensor to sense the inter-vehicle distance and vehicle speeds of vehicles in front and back of the host vehicle.

To this end, the sensing device 200 may include an ultrasonic sensor, a radar, a camera, a laser scanner and/or a corner radar, a LiDAR, an acceleration sensor, a yaw rate sensor, a torque measuring sensor and/or a wheel speed sensor, and a steering angle sensor.

The communication device 300, which is a hardware device implemented with various electronic circuits to transmit or receive a signal through wireless or wired connection, may make vehicle to vehicle (V2V), vehicle to everything (V2X), or vehicle to infrastructure (V2I) communication through an in-vehicle network communication technology or, wireless Internet access or short range communication technology with an external server of a vehicle, an infrastructure, and other vehicles. In this case, the vehicle network communication technology may include a controller area network (CAN) communication technology, a local interconnect network (LIN) communication technology, a FlexRay communication technology, and in-vehicle communication may be performed through the above communication technology. The wireless Internet technology may include a wireless LAN (WLAN), a wireless broadband (Wibro), a Wi-Fi, World Interoperability for Microwave Access (Wimax). The short range communication technology may include Bluetooth, ZigBee, ultra wideband (UWB), radio frequency identification (RFID), or infrared data association (IrDA).

For example, the communication device 300 may allow platooning vehicles on the platooning line to share the platooning information together. In this case, the platoon arrangement information may be stored in the memory 110 as described above.

The interface device 400 may include an input device to receive a control command from a user and an output device to output the operation state and the operation result of the platooning control apparatus 100.

In this case, the input device may include a key button, and may include a mouse, a joystick, a jog shuttle, a stylus pen, or the like. In addition, the input device may include a soft key implemented on a display. For example, the input device may receive, from a user, approval of platooning, release from platooning, inquiry, update and new storage of a platoon arrangement stored in a memory, and approval of Quick start control.

The output device may include the display and may include a voice output device such as a speaker. In the case that a touch sensor, such as a touch film, a touch sheet, or a touch pad, is included in the display, the display may operate as a touch screen, and the input device and the output device may be implemented in the integral form. For example, the output device may display a screen for platoon arrangement information stored in the memory, an approval state for Quick start control of the following vehicles, and the change of the platoon arrangement information stored in the memory.

For example, the output device may output a notification that platoon arrangement information is stored, that there is no platoon arrangement information stored in the memory, that following vehicles reject Quick start, that platooning is failed, and a platoon arrangement verification result.

In this case, the display may include at least one of a liquid crystal display (LCD), a thin film transistor-liquid crystal display (TFT LCD), an organic light-emitting diode (OLED), a flexible display, a field emission display (FED), or a three dimensional display (3D display).

The vehicle control device 500 may be controlled by the platooning control apparatus 100 to control the steering, the acceleration, the deceleration, or the braking of a vehicle.

FIGS. 4 to 8 illustrate screens of a leading vehicle (LV), and hereinafter, the screens of the leading vehicle (LV) will be described with reference to FIGS. 4 to 8 by way of example in detail.

FIG. 2 is a view illustrating a screen of a platoon arrangement, according to an embodiment of the present disclosure, and FIG. 3 is a view illustrating information stored in a memory of a platooning control apparatus, according to an embodiment of the present disclosure.

Referring to FIG. 2, when a leading vehicle (LV) and following vehicles (FV1, FV2, FV3, and FV4) having vehicle IDs of ID1, ID2, ID3, ID4, and ID5 are sequentially arranged and are platooning, that is, when all following vehicles on the platooning line are travelling in ‘Maintain mode’, a present platoon arrangement may be stored in the memory 110.

Referring to FIG. 3, when there are present vehicles (vehicle numbers MV1, MV2, MV3, MV4, and MV5) joined into the platooning line, a role and a vehicle ID may be mapped to each of the vehicles (vehicle numbers MV1, MV2, MV3, MV4, and MV5) and stored. For example, a vehicle having a vehicle number of ‘MV1’ has a role of a leading vehicle (LV) and a vehicle ID of ‘ID1’. Accordingly, a role and a vehicle ID of each vehicle are mapped to each vehicle number and stored.

In addition, whenever the platoon arrangement is changed, the changed platoon arrangement is modified and stored in the memory 110.

FIG. 4 is a view illustrating a screen of a menu for a plurality of memories in a platooning control apparatus, according to an embodiment of the present disclosure, and FIG. 5 is a view illustrating a screen for storing a platoon arrangement in a memory, according to an embodiment of the present disclosure.

For storing the platoon arrangement in the memory 110, the platooning control apparatus 100 of the leading vehicle may first determine whether platooning modes of all following vehicles are ‘Maintain mode’, and may start storing the platoon arrangement, when the platooning modes of the all following vehicles are maintain modes.

The platooning control apparatus 100 of the leading vehicle displays the arrangement of memories as illustrated in FIG. 4, when receiving a request for storing the platoon arrangement from a user through the interface device. In FIG. 4, when memory #1 is selected by the user, as memory #1, memory #2, and memory #3 are displayed, the platooning control apparatus 100 of the leading vehicle may display whether platoon arrangement information, which is previously stored, is present in memory #1.

When the platoon arrangement information, which is previously stored, is present in memory #1, the platooning control apparatus 100 of the leading vehicle may display the platoon arrangement, which is previously stored, such that the user identifies the previously stored platoon arrangement.

Accordingly, the platooning control apparatus 100 of the leading vehicle may receive, from the user, a selection for whether the previously stored platoon arrangement is maintained or overwritten with a present platoon arrangement.

In FIG. 5, when memory #1 has a record (previous platoon arrangement information) which is previously stored, a screen may be displayed to ask the user whether memory #1 is overwritten with new platoon arrangement information.

Accordingly, when a response of “Yes” is selected by the user, the previously stored platoon arrangement is deleted from memory #1, and the present platoon arrangement is newly stored in memory #1. Thereafter, the platoon arrangement stored in memory #1 may be displayed. Accordingly, when a response of “No” is selected by the user, the previously stored platoon arrangement is maintained in memory #1, and the present platoon arrangement is not stored in memory #1.

Hereinafter, an example of rapidly and automatically forming a platoon depending on the previously stored platoon arrangement will be described with reference to FIGS. 6 to 8.

FIG. 6 is a view illustrating a screen of detailed values for a memory, according to an embodiment of the present disclosure, and FIG. 7 is a view illustrating a screen for the setting of Quick start, according to an embodiment of the present disclosure. FIG. 8 is a view illustrating a screen for notifying failure of Quick start, according to an embodiment of the present disclosure.

When a leading vehicle receives a memory number from a user without performing platooning, the platooning control apparatus 100 of the leading vehicle determines whether a platoon arrangement is stored in a memory, and tries to automatically form a platoon depending on the previously stored platoon arrangement. In this case, when there is absent any platoon arrangement previously stored in the memory, the platooning control apparatus 100 of the leading vehicle may notify a user of that there is absent any platoon arrangement previously stored in the memory.

In FIG. 6, an example of displaying platoon arrangement information stored in each of memory #1, memory #2, or memory #3 is disclosed. Accordingly, when a user tries to form a platoon by selecting at least one of memory #1, memory #2, or memory #3, the platooning control apparatus 100 of the leading vehicle may detect information on the approval of Quick start control from the following vehicle, may collect sensor information and vehicle information from the following vehicles to determine whether the following vehicles may instantly form a platooning line.

FIG. 7 illustrates that following vehicles display settings for approving that the leading vehicle of the following vehicles performs Quick start control. In other words, the following vehicle may set, as a passive value, whether Quick start control is approved to the leading vehicle (LV). The set value may be stored in a non-volatile memory of the following vehicle and may be always maintained even if an engine is turned off and then turned on. When the set value is “LV Quick start control not approved” indicating that Quick start control is not approved to the leading vehicle (LV), the leading vehicle (LV) may not perform Quick start. To the contrary, when the set value is “LV Quick start control approved” indicating that Quick start control is approved to the leading vehicle (LV), the leading vehicle (LV) may form a platoon even though the following vehicle does not transmit any request. When even one of the following vehicles belonging to the platooning line is set not to approve Quick start control to the leading vehicle (LV), the platooning control apparatus 100 of the leading vehicle may display that the following vehicle (FV<ID>) does not approve the Quick start such that a user of the leading vehicle (LV) recognizes that Quick start is not approved.

The platooning control apparatus 100 of the leading vehicle determines that all following vehicles approve Quick start, and then determines whether there is present a vehicle failed in platooning, based on sensor information and vehicle information of the following vehicles. When even one of the following vehicles is failed in platooning, the platooning control apparatus 100 of the leading vehicle displays that the platooning of the following vehicle (FV<ID>) is failed, as illustrated in FIG. 8.

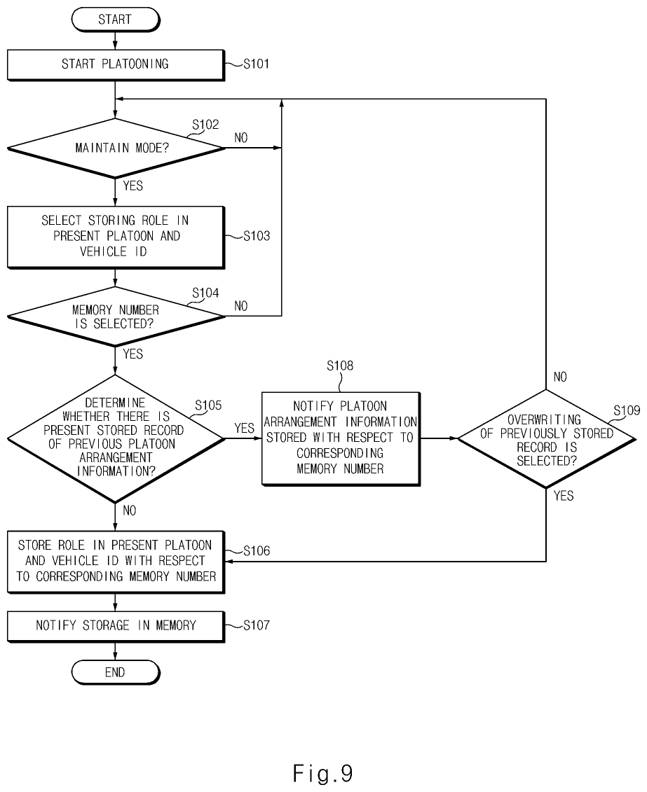

Hereinafter, a storing method of a platoon memory will be described with reference to FIG. 9 according to an embodiment of the present disclosure. FIG. 9 is a flowchart illustrating a storing method of a platoon memory, according to an embodiment of the present disclosure.

The following description will be made on the assumption that the platooning control apparatus 100 of FIG. 1 performs a process of FIG. 9. In addition, in the following description made with reference to FIG. 9, it may be understood that operations described as being performed by an apparatus are controlled by the processor 120 of the platooning control apparatus 100. The procedure of FIG. 9 may be performed by the platooning control apparatus 100 installed in the leading vehicle (LV).

Referring to FIG. 9, the platooning control apparatus 100 determines whether a present platooning mode is ‘Maintain mode’ (S102) after starting platooning (S101).

When the present platooning mode is ‘Maintain mode’, the platooning control apparatus 100 receives a selection for one of memory numbers of the memory 110 (S104), when a user selects storing a role and a vehicle ID of each of present platooning vehicles through the interface device 400 (S103).

In other words, the memory 110 may be classified into a plurality of memory regions, and the plurality of memory regions will be assigned with memory numbers for classification. For example, the memory numbers may be classified as memory #1, memory #2, and memory #3.

The platooning control apparatus 100 determines whether there is present a previously stored record in a memory region corresponding to the memory number which is selected (S105).

When the previously stored record is absent in the memory region corresponding to the selected memory number, the platooning control apparatus 100 stores a present platoon role and a vehicle ID with respect to the corresponding memory number (S106). For example, when memory #1 is selected and when the previously stored record is absent in memory #1, that is, when memory #1 is empty, the present platoon role and the vehicle ID may be stored in memory #1.

Thereafter, the platooning control apparatus 100 may notify a user of present platoon arrangement information (information on a platoon role (sequence) and a vehicle ID of each vehicle) is stored in the memory 110 (S107).

Meanwhile, when previous platoon arrangement information is recorded with respect to the corresponding memory number in S105, the platooning control apparatus 100 provides the platoon arrangement information stored with respect to the corresponding memory number (S108).

Thereafter, the platooning control apparatus 100 determines whether a selection for overwriting the previously stored record is input from the user (S109), and then the present platoon role and the vehicle ID are stored with respect to the corresponding memory number when the overwriting the previously stored record is selected (S106).

To the contrary, when overwriting the previously stored record is not selected, the process returns to S102 while maintaining the previous record.

As described above, according to the present disclosure, the present platoon arrangement information may be stored in the memory, and the stored platoon arrangement information may be identified.

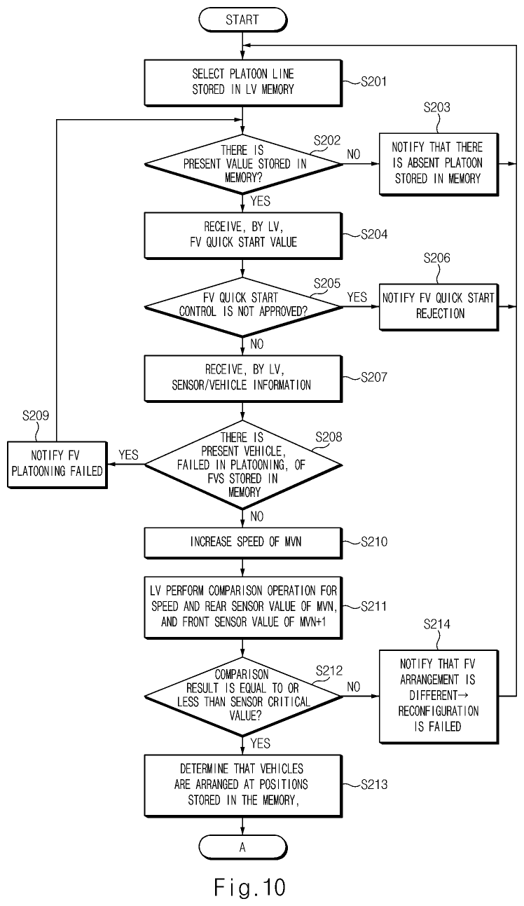

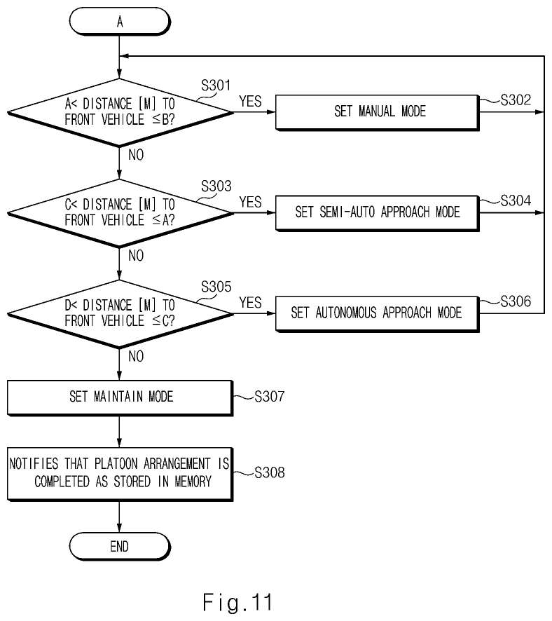

Hereinafter, a method for performing Quick start will be described with reference to FIGS. 10 and 11 in detail according to an embodiment of the present disclosure. FIGS. 10 and 11 are flowcharts illustrating a method for performing Quick start in platooning, according to an embodiment of the present disclosure.

The following description will be made on the assumption that the platooning control apparatus 100 of FIG. 1 performs a process of FIG. 10 or 11. In addition, in the following description made with reference to FIG. 10 or 11, it may be understood that operations described as being performed by an apparatus are controlled by the processor 120 of the platooning control apparatus 100.

Referring to FIG. 10, the platooning control apparatus 100 determines whether there is present a value stored with respect to a corresponding memory number of the memory 110 of a leading vehicle (LV) (S202) when the memory number is selected by a user (S201).

When there is absent the value (previous platoon arrangement information) stored with respect to the corresponding memory number, the platooning control apparatus 100 notifies that a platoon arrangement is not stored with respect to the corresponding memory number (S203).

Meanwhile, when there is present the value stored with respect to the corresponding memory number, the platooning control apparatus 100 of the leading vehicle requests a parameter value for approving Quick start from following vehicles stored with respect to the corresponding memory number and receives the parameter value for approving Quick start (S204).

Accordingly, the platooning control apparatus 100 of the leading vehicle determines whether there is present a following vehicle, which does not approve Quick start control, of following vehicles (S205). When there is present the following vehicle, which does not approve Quick start control, of the following vehicles, the platooning control apparatus 100 of the leading vehicle notifies that the following vehicle rejects Quick start (S206). Accordingly, a driver of the leading vehicle may recognize a vehicle, which has rejected Quick start, of the following vehicles stored with respect to the corresponding memory number. In this case, the leading vehicle notifies the following vehicle, which has rejected Quick start, of that it is difficult to form a platoon arrangement because Quick start is rejected, such that a driver of the following vehicle recognizes that it is difficult to form the platoon arrangement.

Meanwhile, when there is absent a following vehicle, which does not approve Quick start control, of following vehicles stored with respect to the corresponding memory number, that is, when all following vehicles have approved Quick start control, the platooning control apparatus 100 requests and receives sensor information and vehicle information from the following vehicles stored with respect to the corresponding memory number (S207)

The platooning control apparatus 100 of the leading vehicle determines whether there is present a following vehicle, which is failed in platooning, of the following vehicles stored in the memory, by using the sensor information and the vehicle information received from the following vehicles and stored with respect to the memory (S208). In other words, when it is determined that a sensor is failed, a vehicle control is failed, and the distance to a front vehicle is within a preset distance, based on the sensor information and the vehicle information received from the following vehicles stored with respect to the memory number, the platooning control apparatus 100 of the leading vehicle may determine the vehicle as being failed in platooning.

As described above, when there is present a vehicle, which is failed in platooning, of the following vehicles stored with respect to the corresponding memory number, the platooning control apparatus 100 of the leading vehicle notifies platooning failed (S209). Accordingly, the driver of the leading vehicle may recognize the platooning failed.

When there is absent a vehicle, which is failed in platooning, of the following vehicles stored with respect to the corresponding memory number, the platooning control apparatus 100 of the leading vehicle increases the speed of the following vehicles (MVn) stored with respect to the corresponding memory number (S210). Accordingly, the following vehicles stored with respect to the corresponding memory number are moved to arrangement positions stored with respect to the corresponding memory number.

Thereafter, the platooning control apparatus 100 of the leading vehicle may determine whether the following vehicles are arranged at the arrangement positions stored with respect to the corresponding memory number, by using sensor values of platooning vehicles.

The platooning control apparatus 100 of the leading vehicle performs a comparison operation for a speed and a rear sensor value of a front vehicle (MVn) of the following vehicles and a front sensor value of a rear vehicle (MVn+1) of the following vehicles (S211) and determines whether the comparison result is less than or equal to the preset critical value (S212).

For example, the platooning control apparatus 100 of the leading vehicle (LV) slowly increases the speed of a host vehicle, compares the speed of a front vehicle (leading vehicle), which is measured by a front sensor of the following vehicle (FV1) (rear vehicle), with the speed of the leading vehicle, which is measured by the leading vehicle, and determines whether the comparison result is equal to or less than the preset critical value.

Accordingly, when the comparison result is equal to or less than the preset critical value, the platooning control apparatus 100 of the leading vehicle determines that the following vehicle (FV1) is positioned in rear of the leading vehicle (LV). When the comparison result exceeds the preset critical value, the platooning control apparatus 100 of the leading vehicle determines that the following vehicle (FV1) is not positioned in rear of the leading vehicle (LV).

The platooning control apparatus 100 of the leading vehicle may perform S212 with respect to each of following vehicles stored with respect to the memory number to determine whether vehicles are arranged at positions stored in the memory.

The platooning control apparatus 100 of the leading vehicle performs comparison with respect to all vehicles on the platoon string, and may determine that the vehicles are arranged at positions stored in the memory, when the comparison results are equal to or less than the preset critical value (S213). Accordingly, platooning may be started.

When the platooning control apparatus 100 of the leading vehicle performs comparison with respect to all vehicles on the platoon string, and when there is present a value, which exceeds the critical value, of the comparison results, the platooning control apparatus 100 may determine that the relevant following vehicle is not arranged at the position stored in the memory, and notifies the relevant following vehicle that the relevant following vehicle is not arranged at the position stored with respect to the memory number and that reconfiguration is failed (S214). In this case, the platooning control apparatus 100 of the leading vehicle may recommend the relevant following vehicle to be arranged at the position stored with respect to the memory number.

For example, the platooning control apparatus 100 of the leading vehicle may compare the speed of the leading vehicle (LV) with the speed of the leading vehicle (LV), which is measured by a front sensor of the following vehicle (FV1), may compare the speed of the following vehicle (FV1) with the speed of the following vehicle (FV1), which is measured by a front sensor of the following vehicle (FV2), and may compare the speed of the following vehicle (FV2) with the speed of the following vehicle (FV2), which is measured by a front sensor of the following vehicle (FV3). As described above, the platooning control apparatus 100 of the leading vehicle may perform the comparison operation with respect to all vehicles on the platoon string and may determine that the vehicles are arranged at the positions stored in the memory, when all comparison result values are equal to or less than the preset critical value. Meanwhile, when even one of the comparison values the leading vehicle (LV), the following vehicle (FV1), the following vehicle (FV2), and the following vehicle (FV3) exceeds the preset critical value, it is determined that the relevant vehicle is not arranged at the position stored with respect to the memory number.

The following description will be made with reference to FIG. 11 regarding a procedure of transmitting a command for the platooning mode when all vehicles are arranged identically to the arrangement stored in the memory as in S213 of FIG. 10.

The platooning control apparatus 100 of the leading vehicle transmits the command for the platooning to following vehicles on the platooning line in parallel. In this case, the command for the platooning mode may be set variously depending on the distance between the following vehicle and a vehicle in front of the following vehicle.

In this case, S301 to S305 are determined with respect to all the following vehicles, and the command for the platooning mode is transmitted to relevant vehicles depending on the determination results. However, for the convenience of explanation, the following description will be made regarding one example of determining a command for a platooning mode by determining the inter-vehicle distance between one following vehicle and a vehicle in front of the following vehicle.

The platooning control apparatus 100 of the leading vehicle determines whether the distance between a following vehicle (FV2) and a following vehicle (FV1) in front of the following vehicle (FV2) is greater than a preset reference value ‘A’ and equal to or less than a preset reference value ‘B’ (S301). In this case, the preset reference value ‘A’ may be set to be less than the preset reference value ‘B’ based on experimental values.

The platooning control apparatus 100 of the leading vehicle sets the command for the platooning mode to be in ‘Manual mode’, when the distance between the following vehicle (FV2) and the following vehicle (FV1) in front of the following vehicle (FV2) is greater than the preset reference value ‘A’ and equal to or less than the preset reference value ‘B’ (S302). In this case, in the manual mode, a driver may perform all longitudinal control and lateral control.

To the contrary, the platooning control apparatus 100 of the leading vehicle determines whether the distance between the following vehicle (FV2) and the following vehicle (FV1) in front of the following vehicle (FV2) is greater than a preset reference value ‘C’ and equal to or less than a preset reference value ‘A’, when the distance between the following vehicle (FV2) and the following vehicle (FV1) in front of the following vehicle (FV2) fails to satisfy a condition of beings greater than the preset reference value ‘A’ and equal to or less than the preset reference value ‘B’ (S303). In this case, the preset reference value ‘C’ may be set to be less than the preset reference value ‘A’ based on experimental values.

The platooning control apparatus 100 of the leading vehicle sets the command for the platooning mode for the following vehicle (FV2) to be in ‘Semi-auto approach mode’, when the distance between the following vehicle (FV2) and the following vehicle (FV1) in front of the following vehicle (FV2) is greater than the preset reference value ‘C’ and equal to or less than the preset reference value ‘A’ (S304). In ‘Semi-auto approach mode’, the platooning control apparatus 100 performs the longitudinal control over a vehicle and the driver personally performs lateral control.

The platooning control apparatus 100 of the leading vehicle determines whether the distance between the following vehicle (FV2) and the following vehicle (FV1) in front of the following vehicle (FV2) is greater than a preset reference value ‘D’ and equal to or less than a preset reference value ‘C’, when the distance between the following vehicle (FV2) and the following vehicle (FV1) in front of the following vehicle (FV2) fails to satisfy a condition of beings greater than the preset reference value ‘C’ and equal to or less than the preset reference value ‘A’ (S305). In this case, the preset reference value ‘D’ may be set to be less than the preset reference value ‘C’ based on experimental values.

The platooning control apparatus 100 of the leading vehicle sets the command for the platooning mode to be in “Autonomous approach mode’, when the distance between the following vehicle (FV2) and the following vehicle (FV1) in front of the following vehicle (FV2) is greater than the preset reference value ‘D’ and equal to or less than the preset reference value ‘C’ (S306). In ‘Autonomous approach mode’, the platooning control apparatus 100 performs all the longitudinal control and the lateral control over the vehicle.

The platooning control apparatus 100 of the leading vehicle may set the command for the platooning mode for the following vehicle (FV2) to be in ‘Maintain mode’, when the distance between the following vehicle (FV2) and the following vehicle (FV1) in front of the following vehicle (FV2) fails to satisfy a condition of beings greater than the preset reference value ‘D’ and equal to or less than the preset reference value ‘C’ (S307). In ‘Maintain mode’, the platooning control apparatus 100 performs all the longitudinal control and the lateral control over the vehicle and inter-vehicle distance control. As described above, when all following vehicles on a platoon string enter ‘Maintain mode’, the platooning may be started and the present platoon arrangement may be stored in the memory 110. In addition, whenever the platoon arrangement is changed, the changed platoon arrangement is modified and stored in the memory 110. In this case, as illustrated in FIG. 3, when the platoon arrangement is stored, the vehicle IDs and roles of the platooning vehicles may be stored.

Although the following vehicle (FV2) will be described by way of example in the above procedure, the platooning control apparatus 100 of the leading vehicle performs the above procedure with respect to all following vehicles in parallel, and transmits the command for the platooning mode to all following vehicles in parallel, such that the platooning is rapidly performed.

Thereafter, the platooning control apparatus 100 of the leading vehicle notifies that the platoon arrangement is completed as stored in the memory (S308). Accordingly, the driver of the leading vehicle may recognize that the platoon arrangement is completed, and each following vehicle notifies a relevant driver of that the platoon arrangement is completed as stored in the memory, thereby allowing even the driver of each following vehicle to recognize the platoon arrangement completed.

As described above, according to the present disclosure, when a platoon is formed after dismissed, platooning may be rapidly performed together with vehicles which have previously ever formed the platoon.

In other words, according to the present disclosure, the platooning may be rapidly started without the procedure in which when the following vehicles, which have previously ever formed a platoon, request platooning, the leading vehicle approves the platooning to form a platoon. In addition, since all following vehicles are controlled in parallel, time spent to first start the platooning may be saved.

In addition, a user effort to form a platoon after dismissing the platoon may be reduced, so the user may take a break.

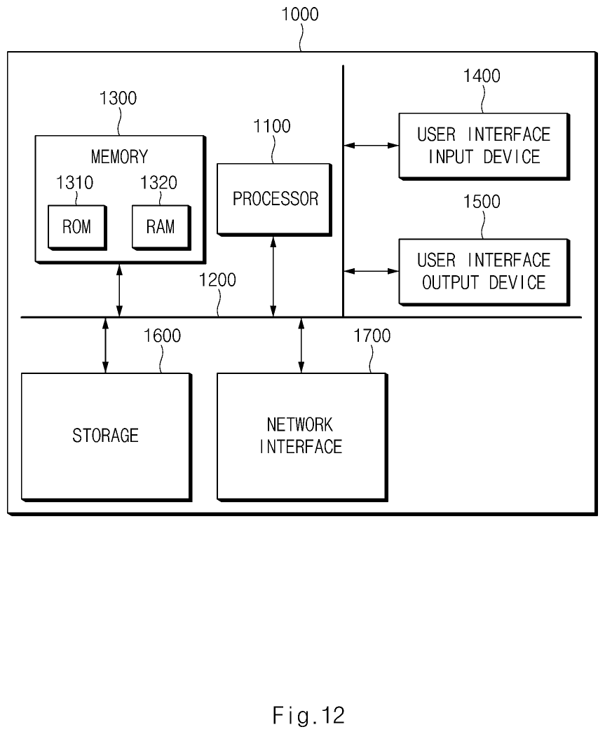

FIG. 12 is a block diagram illustrating a computing device according to an embodiment of the present disclosure.

Referring to FIG. 12, a computing system 1000 may include at least one processor 1100, a memory 1300, a user interface input device 1400, a user interface output device 1500, a storage 1600, and a network interface 1700, which are connected with each other via a system bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the embodiments disclosed in the present disclosure may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM).

The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

According to the present disclosure, information on a platoon arrangement may be stored in the memory, the request and approval procedures may be skipped when the platoon is formed thereafter, and the platooning may be directly performed based on the information on the platoon arrangement stored in the memory, thereby minimizing an inconvenient work of re-foiling the previous platoon after releasing the platooning.

Besides, a variety of effects directly or indirectly understood through the disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of protection of the present disclosure should be construed by the attached claims, and all equivalents thereof should be construed as being included within the scope of the present disclosure.

What is claimed is:

1. An apparatus for controlling platooning, the apparatus comprising:
a processor configured to control the platooning; and
a memory configured to store platoon arrangement information of platooning vehicles during the platooning,
wherein the processor is configured to:
automatically form a platoon based on the platoon arrangement information when controlling the platooning.

2. The apparatus of claim 1, wherein the memory is configured to:
store the platoon arrangement information by mapping a role on the platooning line to a vehicle identification (ID) of each of the platooning vehicles.

3. The apparatus of claim 1, wherein the processor is configured to:
cause the memory to store present platoon arrangement information of the platooning vehicles when the platooning vehicles are in a maintain mode.

4. The apparatus of claim 1, wherein the processor is configured to:
determine whether previously stored platoon arrangement information is present in a memory region, which is selected by a user, when storing the platoon arrangement information in the memory; and
provide the previously stored platoon arrangement information when the previously stored platoon arrangement information is present.

5. The apparatus of claim 4, wherein the processor is configured to:
delete the previously stored platoon arrangement information in response to a request of the user; and
store present platoon arrangement information, when the previously stored platoon arrangement information is present.

6. The apparatus of claim 3, wherein the processor is configured to:
notify that the present platoon arrangement information is stored in the memory.

7. The apparatus of claim 1, wherein the processor is configured to:
determine whether to set approval of Quick-start control over the platooning vehicles corresponding to the platoon arrangement information stored in the memory; and
automatically form the platoon.

8. The apparatus of claim 7, wherein the processor is configured to:
receive, from following vehicles of the platooning vehicles, setting information for approval of Quick-start control over the following vehicles; and
determine whether a vehicle, which does not approve the Quick-start control, of the following vehicles is present.

9. The apparatus of claim 8, wherein the processor is configured to:
determine that automatic platooning is failed, when at least one following vehicle, which does not approve the Quick-start control, of the following vehicles is present; and
notify that the automatic platooning is failed.

10. The apparatus of claim 8, wherein the processor is configured to:
determine whether the platooning is possible by receiving sensor information and vehicle information from the following vehicles, when all the following vehicles approve the Quick-start control.

11. The apparatus of claim 10, wherein the processor is configured to:
determine and notify that the platooning is failed when it is determined that a sensor is failed, an engine is turned off, a vehicle control is failed, and a distance to a front vehicle is within a preset distance, based on the sensor information and the vehicle information received from the following vehicles.

12. The apparatus of claim 10, wherein the processor is configured to:
determine whether the platooning vehicles are arranged based on the platoon arrangement information stored in the memory, when the platooning is possible; and
start the platooning when the platooning vehicles are arranged based on the platoon arrangement information stored in the memory.

13. The apparatus of claim 10, wherein the processor is configured to:
compare a speed of a first following vehicle of the following vehicles with a speed of the first following vehicle, which is measured by a front sensor of a second following vehicle travelling behind the first following vehicle, when the platooning is possible;
determine whether the second following vehicle is travelling behind the first following vehicle; and
verify the platoon arrangement.

14. The apparatus of claim 13, wherein the processor is configured to:
verify the platoon arrangement with respect to all the following vehicles; and
start the platooning when the verification of the platoon arrangement is completed with respect to all the following vehicles.

15. The apparatus of claim 13, wherein the processor is configured to:
notify that the verification of the platoon arrangement is failed with respect to at least one of the following vehicles, when the verification of the platoon arrangement is failed with respect to the at least one of the following vehicles.

16. The apparatus of claim 12, wherein the processor is configured to:
determine platooning modes of all following vehicles based on inter-vehicle distances between all the following vehicles and front vehicles of all the following vehicles, when the platooning is started.

17. The apparatus of claim 16, wherein the processor is configured to:
determine the platooning mode to be a manual mode when the inter-vehicle distance is longer than a first reference value;
determine the platooning mode to be a semi-auto approach mode when the inter-vehicle distance is longer than a second reference value and shorter the first reference value, wherein the second reference value is shorter than the first reference value;
determine the platooning mode to be an autonomous approach mode, when the inter-vehicle distance is longer than a third reference value and shorter the second reference value, wherein the third reference value is shorter than the second reference value; and
determine the platooning mode to be a maintain mode, when the inter-vehicle distance is longer than a fourth reference value and shorter the third reference value, wherein the fourth reference value is shorter than the third reference value.

18. The apparatus of claim 17, wherein the processor is configured to:
transmit a command for the platooning mode to all the following vehicles in parallel such that all the following vehicles perform the platooning mode in parallel.

19. A vehicle system comprising:
a communication device configured to communicate among platooning vehicles;
a platooning control apparatus configured to:
store platoon arrangement information of the platooning vehicles during controlling the platooning; and
automatically perform the platooning based on the stored platoon arrangement information when controlling the platooning; and
an interface device configured to display the platoon arrangement information.

20. A method for controlling platooning, the method comprising:
storing platoon arrangement information of platooning vehicles during the platooning; and
automatically performing the platooning based on the stored platoon arrangement information when controlling the platooning.
